(19) United States
(12) Patent Application Publication
(10) Pub. No.: US 2005/0242968 A1
(43) Pub. Date: Nov. 3, 2005

(54) Carbon monoxide heating unit shut down switch

(76) Inventor: Raymond C. Reid, Bay Shore, NY (US)

Correspondence Address: Raymond C. Reid, 1073 CALLAHAN ST., BAY SHORE, NY, 11706, US

(21) Appl. No.: 10/795,647

(22) Filed: Mar. 8, 2004

(51) Int. Cl. G08B 17/10

(52) U.S. Cl. 340/632; 307/116

(57) ABSTRACT

A Carbon Monoxide Heating Unit Shut Down Switch which shuts down a heating unit that is producing Carbon Monoxide which is fatal to the inhabitants of a Residential, Commercial or Industrial building. It will shut down oil fired, gas fired and propane fired heating unit when unacceptable levels of Carbon Monoxide is detected 10 feet to 15 feet from heating unit and not when it has spread to the rest of the dwelling, preventing fatalities. The warning device will also sound an alarm with a flashing light when relay is switched disconnecting power to the burner. After the Carbon Monoxide is cleared from 10 feet to 15 feet from heating unit area, reset button can be pushed reestablishing electrical connection to the burner, burner can be safely restarted. The Carbon Monoxide Heating Unit Shut Down Switch is powered externally from 115VAC or 220VAC or various other voltages to power burner.

### BACKGROUND

1. Field of Invention

The Carbon Monoxide Heating Unit Shut Down Switch relates to an oil fired, gas fired or propane fired combustion shut down switch preventing the further production of Carbon Monoxide.

2. Discussion of Prior Art

The only prior art I could find relates to the shut down of blower motor, Patent Application 20010045895. The Carbon Monoxide Shut Down Switch differs, in it detects and shuts down combustion of the heating unit, which may be defective, producing unsafe levels of Carbon Monoxide. By shutting down the combustion of the heating unit, you are stopping the Carbon Monoxide at the source not just the proliferation of Carbon Monoxide. Also the Carbon Monoxide Heating Unit Shut Down Switch is mounted 10 feet to 15 feet from heating unit, unlike Carbon Monoxide detectors that are mounted throughout the dwelling space.

The invention of Carbon Monoxide detectors has protected inhabitants by warning them of the presence of Carbon Monoxide by sounding an alarm, but does not have the ability to stop the source of the Carbon Monoxide.

### BREIF SUMMARY OF INVENTION

The Carbon Monoxide Heating Unit Shut Down Switch is a device that will shut off a residential, commercial and industrial heating system in the event there is Carbon Monoxide present 10 feet to 15 feet from the heating system. The Carbon Monoxide Heating Unit Shut Down Switch is wired to the main power switch of a burner on a oil fired, gas fired or propane fired unit. The Carbon Monoxide Heating Unit Shut Down Switch will prevent proliferation of Carbon Monoxide into the dwelling area, preventing harm to the inhabitants. The device is equipped with a alarm and a reset button. When there is no more detectable Carbon Monoxide 10 feet to 15 feet from burner, the reset button can be pushed, reestablishing the circuit between the burner and the main switch. The Carbon Monoxide Heating Unit Shut Down Switch utilizes a relay to connect and disconnect power supply to burner. The relay can be electrical or electronic. The Carbon Monoxide Heating Unit Shut Down Switch can be wired directly using Romex wire or conduit according to NEC electrical code, or plug receptacles could be used to make electrical connections.

### BRIEF DESCRIPTION OF DRAWINGS

FIG. 1 is a perspective view of heating unit with Carbon Monoxide Heating Unit Shut Down Switch wired in series with main shut down switch.

FIG. 2 is a perspective close up view of the Carbon Monoxide Heating Unit Shut Down Switch.

### DETAILED DESCRIPTION OF THE PREFERRED EMBODIMENTS

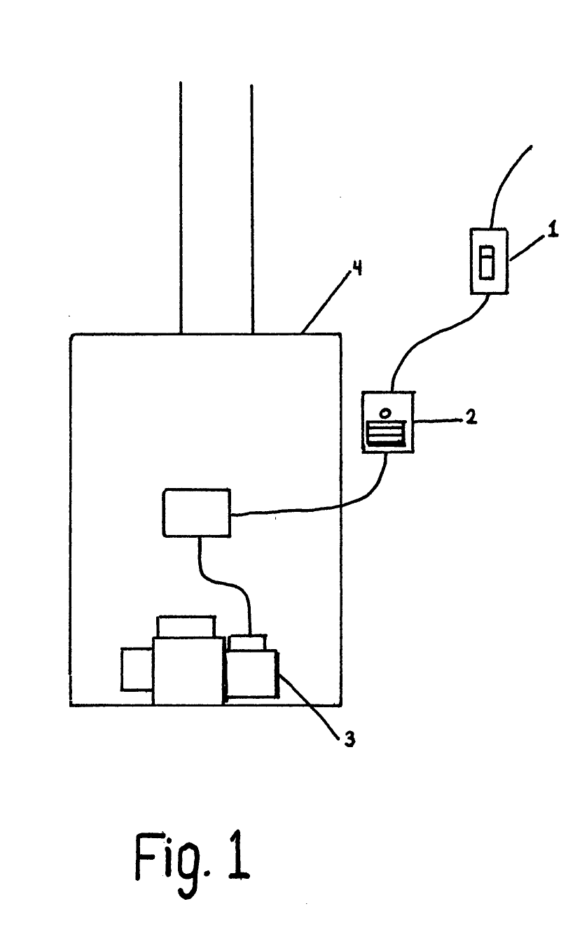

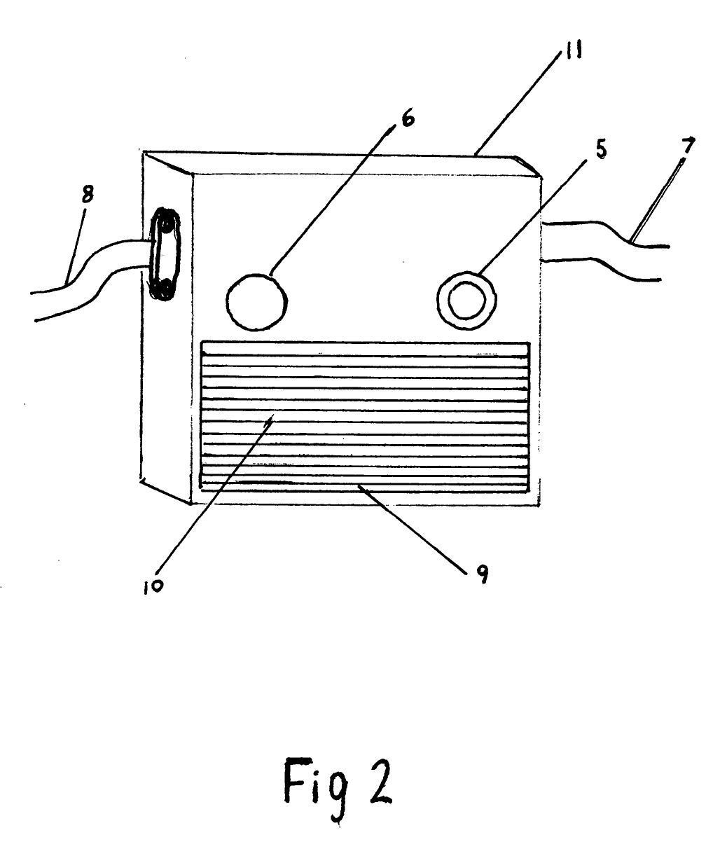

Referring now to FIG. 1 which is a drawing of a heating unit. The main power switch 1 is wired in series to the Carbon Monoxide Heating Unit Shut Down Switch 2, which is wired to burner control 3, which is mounted 10′ to 15′ from heating unit 4, to prevent erroneous alarms. When unacceptable levels of Carbon Monoxide is detected by 2, a relay disconnects power to burner motor 3, stopping the combustion process. Also referring to FIG. 2 When Carbon Monoxide is detected within 10′ to 15′ of heating unit 4, warning light 6, lights and alarm sounds 10. In FIG. 2 shows wire ,115VAC or 220VAC which is input power from FIG. 1. Main power switch 1. In FIG. 2 wire proceeding from Carbon Monoxide Heating Unit Shut Down Switch 11, is a 115VAC or 220 VAC output line connected to heating unit FIG. 1 number 3. Referring to FIG. 2 when area 10′ to 15′ from heating unit is free from unacceptable levels of Carbon Monoxide, reset button 5. Is pushed re-establishing electrical connection from wire 7. To wire 8, burner 3 in FIG. 1. can be restarted, if unacceptable levels of Carbon Monoxide is still being produced, heating unit will shut down again. Carbon Monoxide detector 9. is located in Carbon Monoxide Heating Unit Shut Down Switch 11. FIG. 2.

Referring to FIG. 1 Heating Unit 4, can be oil fired, gas fired or propane fired heating unit, Carbon Monoxide Heating Unit Shut Down Switch will shut down gas supply valve stopping combustion

1. The Carbon Monoxide Heating Unit Shut Down Switch, shuts down combustion of a oil fired, gas fired or propane heating unit. When the presence of Carbon Monoxide is detected 10 feet to 15 feet from burner.

2. The switch is fully automatic

3. The Carbon Monoxide detector can be incorporated with the switch in one unit.
